(19) United States
(12) Patent Application Publication
(10) Pub. No.: US 2018/0290229 A1
(43) Pub. Date: Oct. 11, 2018

(54) GAS SUPPLY DEVICE, GAS SUPPLY DEVICE HAVING MIXING FUNCTION, WELDING DEVICE, AND GAS SUPPLY METHOD

(71) Applicant: TAIYO NIPPON SANSO CORPORATION, Tokyo (JP)

(72) Inventors: Katsunori WADA, Kai-shi (JP); Kazufumi TODA, Kai-shi (JP)

(21) Appl. No.: 15/754,354

(22) PCT Filed: Sep. 27, 2016
(86) PCT No.: PCT/JP2016/078525

§ 371 Date: Feb. 22, 2018

(30) Foreign Application Priority Data
Sep. 28, 2015 (JP) 2015-189080

(51) Int. Cl. B23K 9/173; F17C 13/00

(52) U.S. Cl. CPC B23K 9/173; F17C 13/002

(57) ABSTRACT

An object of the present invention to provide a gas supply device, a gas supply device having a mixing function, a welding device, and a gas supply method, which can prevent rush flow of gas from the gas supply source in the initial stage of gas lead-out from a gas supply source, reduce the cost, and improve the maintenance; and the present invention provides a gas supply device including a gas supply source into which a gas is filled at a high pressure, a single-stage decompressor which is provided at a gas outlet of the gas supply source and which is configured to reduce pressure of a gas led out from the gas supply source to a predetermined pressure, a gas supply line having one end connected to the single-stage decompressor and the other end connected to a use destination of the gas, a solenoid valve provided in the gas supply line, and a flow regulating valve provided in the gas supply line located between the solenoid valve and the use destination.

### TECHNICAL FIELD

The present invention relates to a gas supply device, a gas supply device having a mixing function, a welding device, and a gas supply method.

Priority is claimed on Japanese Patent Application No. 2015-189080, filed Sep. 28, 2015, the content of which is incorporated herein by reference.

### BACKGROUND ART

Conventionally, when gas is supplied from a gas supply source filled with gas at a high pressure to a user, after the pressur of the gas to be led out from the gas supply source (for example, a cylinder) is sufficiently lowered, and then the gas is supplied to he use destination.

Such a technique supply device) is also applied to an arc welding device.

Arc welding is the most widely used welding process due to low cost and high versatility. The arc welding roughly divided into Gas Tungsten Arc welding (hereinafter referred to as “GTA welding”) using a non-consumable electrode and Gas Metal Arc welding (hereinafter referred to as “GMA welding”) using a consumable electrode.

In the GTA welding, a high melting metal (for example, tungsten) is used as a material of a cathode, a plasma is generated via an arc discharge generated between the cathode and a base material serving as an anode, and the base material is fusion-bonded using the plasma as a heat source.

On the other hand, in the GMA welding, a welding wire is used as an anode and the base material is used as a cathode. In the GMA welding, a welding wire is melted by arc plasma to form a droplet at the wire end, the droplet undergoes an external force to disengage the wire end, transfers to the base material, and thereby welding is carried out.

FIG. 17 is a schematic diagram showing a configuration of a conventional GMA welding device equipped with a conventional gas supply device.

Next, referring to FIG. 17, a conventional GMA welding device 100 will be described.

The conventional GMA welding device 100 has a gas supply device 101, a welding device 103, a wire feeding device 105, and a welding torch 106.

The gas supply device 101 has a gas supply source 111, a dual-stage decompressor 112, a gas supply line 113, and a solenoid valve 115.

As the gas supply source 111, for example, a cylinder filled with a shielding gas at a high pressure can be used.

The dual-stage decompressor 112 is provided in the gas lead-out portion of the gas supply source 111, and is connected to one end of the gas supply line 113. The dual-stage decompressor 112 has a function of saving the shielding gas by suppressing rush flow of the shielding gas (a phenomenon in which a gas with a larger flow than the desired flow is released), which is likely to occur in the initial stage (the initial stage of welding), at which the gas is led out from the high-pressure-filled gas supply source 111. As the dual-stage decompressor 112, for example, a gas regulator disclosed in Patent Document 1 can be used.

FIG. 18 is a diagram showing an example of a conventional dual-stage decompressor.

Here, referring to FIG. 18, an example of a conventional dual-stage decompressor 116 will be described.

The conventional dual-stage decompressor 116 includes a joint 116A, a first-stage pressure reducing unit 116B, a regulating pressure gauge 116C, a second-stage pressure reducing unit 116F, a nozzle 116E, and a flow meter 116D.

A high-pressure gas is introduced from the joint 116A to the first-stage pressure reducing unit 116B and depressurized to a predetermined pressure. The depressurized gas is further introduced into the second-stage pressure reducing unit 116F, the pressure is reduced to a working pressure, and the gas having a working pressure is discharged from the nozzle 116E. The amount of used gas is indicated in the flow meter 116D. The pressure applied to the joint 116A is indicated in the regulating pressure gauge 1160.

The other end of the gas supply line 113 is connected to the welding torch 106. The gas supply line 113 supplies the shielding gas to the welding torch 106.

The solenoid valve 115 is provided in the gas supply line 113 located in the wire feeding device 105. When the solenoid valve 115 opens, the shielding gas is supplied to the welding torch 106.

The welding device 103 is provided in a gas supply line 113 located at the latter stage of the dual-stage decompressor 112.

The wire feeding device 105 supplies the wire to the welding torch 106. The welding torch 106 welds an workpiece to be welded (not shown).

FIG. 19 is a schematic diagram showing a configuration of a conventional GTA welding including a conventional gas supply device.

Next, referring to FIG. 19, a conventional GTA welding device 120 will be described.

The conventional GTA welding device 120 is configured similarly to the GMA welding device 100 shown in FIG. 17, except that the wire feeding device 105 is excluded, a welding device 121 and a welding torch 122 are provided instead of the welding device 103 and the welding torch 106, and the arrangement position of the solenoid valve 115 is different.

The welding device 121 is provided in a gas supply line 113 located between the dual-stage decompressor 112 and the welding torch 122. The solenoid valve 115 is provided in the gas supply line 113 located in the welding device 121.

### PRIOR ART DOCUMENTS

### Patent Literature

Patent Document 1 Japanese Examined Utility Model (Registration) Application Publication No. S62-113875

### SUMMARY OF INVENTION

### Problem to be Solved by the Invention

However, since the dual-stage decompressor 112 has a complicated structure, it is difficult to perform maintenance.

In addition, the dual-stage decompressor 112 has a problem of high cost.

It is therefore an object of the present invention to provide a gas supply device, a gas supply device having a mixing function, a welding device, and a gas supply method, which can prevent rush flow of gas from the gas supply source in the initial stage of gas lead-out from a gas supply source, reduce the cost, and improve the maintenance.

### Means for Solving the Problem

In order to solve the problems above, the present invention provides the following gas supply device, gas supply device having a mixing function, welding device, and gas supply method.

(1) A gas supply device including a gas supply source into which a gas is filled at a high pressure, a single-stage decompressor which is provided at a gas outlet of the gas supply source and which is configured to reduce pressure of a gas led out from the gas supply source to a predetermined pressure, a gas supply line having one end connected to the single-stage decompressor and the other end connected to a use destination of the gas, a solenoid valve provided in the gas supply line, and a flow regulating valve provided in the gas supply line located between the solenoid valve and the use destination.

(2) The gas supply device according to (1), wherein the gas supply device includes a constant flow valve provided in the gas supply line located in a latter stage of the solenoid valve instead of the flow regulating valve, and a first branch line which is branched from the gas supply line located in a former stage of the solenoid valve and connected to the constant flow valve.

(3) The gas supply device according to (1), wherein the flow regulating valve is a needle valve.

(4) The gas supply device according to (1) or (3), wherein the gas supply device further includes a flow meter which is provided in the gas supply line located in a latter stage of the flow regulating valve and measures the flow of the gas.

(5) The gas supply device according to any one of (1) to (4), wherein the gas supply device includes a pilot gas supply source which is configured to supply a pilot gas instead of the shield gas supply source, and a pilot gas supply line in which the pilot gas flows instead of the shield gas supply line:.

(6) A gas supply device having a mixing function including a plurality of gas supply devices according to any one of (1) to (4), and a line which has one end connected to each shield gas supply line in the plurality of gas supply device and the other end connected to the use destination, and has a function of mixing together a plurality of the shield gases.

(7) The gas supply device having a mixing function according to (6), wherein the gas supply device having a mixing function further includes a solenoid valve control unit which is electrically connected to the solenoid valve in the plurality of gas supply device and is configured to control the solenoid valve, and the solenoid valve control unit is a current sensor which uses a magnetic core.

(8) A welding device including the gas supply device according to any one of (1) to (4), the use destination is a welding torch, and the gas supply device configured to supply the shielding gas.

(9) A welding device including the gas supply device according to any one of (1) to (4), a GMA welding device provided in the shield gas supply line located between the solenoid valve and the single-stage decompressor, a second branch line branched from the shield gas supply line located between the single-stage decompressor and the GMA welding device, another solenoid valve provided in the second branch line, another flow regulating valve provided in the second branch line located at the latter stage of the other solenoid valve, and another GTA welding device which is configured to control the other solenoid valve.

(10) A gas supply method including:

a decompression step in which the pressure of the shield gas is reduced by using the single-stage decompressor so that the pressure of the shielding gas led out from the gas supply source filled with the shielding gas at high pressure becomes a predetermined pressure; and

a back pressure applying step in which when the solenoid valve is opened and closed, which is provided in the gas supply line of which one end is connected to the single-stage decompressor and the other end is connected to a use destination of the shielding gas, a back pressure is applied in the gas supply line positioned on the upstream side of the flow regulating valve by the flow regulating valve disposed at the latter stage of the solenoid valve.

(11) The gas supply method according to (10), wherein the use destination of the shield gas is a welding torch and the shield gas is used.

(12) The gas supply method according to (10) or (11), wherein a pilot gas is supplied instead of the shield gas.

### Effects of the Invention

According to the present invention, it is possible to prevent the rush flow of gas generated at an initial stage of gas lead-out from the gas supply source, reduce the cost, and improve the maintenance.

### BRIEF DESCRIPTION OF DRAWINGS

FIG. 1 is a schematic diagram showing a configuration of a welding device according to a first embodiment of the present invention.

FIG. 2 is a schematic diagram showing a configuration of a welding device according to a second embodiment of the present invention.

FIG. 3 is a schematic diagram showing a configuration of a welding device according to a first modification of the second embodiment of the present invention.

FIG. 4 is a schematic diagram showing a configuration of a welding device according to a second modification of the second embodiment of the present invention.

FIG. 5 is a schematic diagram showing a configuration of a welding device according to a third embodiment of the present invention.

FIG. 6 is a schematic diagram showing a configuration of a welding device according to a fourth embodiment of the present invention.

FIG. 7 is a schematic diagram showing a configuration of a welding device according to a fifth embodiment of the present invention.

FIG. 8 is a diagram showing an example of a gas supply device having a mixing function that can use three types of shielding gas.

FIG. 9 is a graph showing the relationship between the instantaneous flow and the elapsed time when the flow of the shielding gas is 20 L/min and the pressure setting on the outlet side (exit side) of the gas supply source is 0.2 MPa in Comparative Example 1.

FIG. 10 is a graph showing the relationship between the instantaneous flow and the elapsed time when the flow of the shielding gas is 20 L/min and the pressure setting on the outlet side (exit side) of the gas supply source is 0.2 MPa in Example 1.

FIG. 11 is a graph showing the relationship between the instantaneous flow and the elapsed time when the flow of the shielding gas is 5 L/min and the pressure setting on the outlet side (exit side) of the gas supply source is 0.22 MPa in Comparative Example 1.

FIG. 12 is a graph showing the relationship between the instantaneous flow and the elapsed time when the flow of the shielding gas is 5 L/min and the pressure setting on the outlet side (exit side) of the gas supply source is 0.22 MPa in Example 1.

FIG. 13 is a graph showing the relationship between the instantaneous flow and the elapsed time when the flow of the shielding gas is 5 L/min and the pressure setting on the outlet side (exit side) of the gas supply source is 0.7 MPa in Example 2.

FIG. 14 is a graph showing the relationship between the instantaneous flow and the elapsed time when the length of the gas supply line located between the solenoid valve and the flow regulating valve in the welding device shown in FIG. 1 is set to 5,300 m, the flow of the shielding gas is 20 L/min, and the pressure setting on the outlet side (exit side) of the gas supply source is 0.2 MPa in Example 3.

FIG. 15 is a graph showing the relationship between the instantaneous flow and the elapsed time when the length of the gas supply line located between the solenoid valve and the flow regulating valve in the welding device shown in FIG. 1 is set to 5,300 m, the flow of the shielding gas is 5 L/min, and the pressure setting on the outlet side (exit side) of the gas supply source is 0.2 MPa in Example 4.

FIG. 16 is a graph showing the relationship between the instantaneous flow and the elapsed time when the flow of the shielding gas is 20 L/min and the pressure setting on the outlet side (exit side) of the gas supply source is 0.2 MPa in Comparative Example 2.

FIG. 17 is a schematic diagram showing a configuration of a conventional GMA welding device including a conventional gas supply device.

FIG. 18 is a diagram showing an example of a conventional dual-stage decompressor.

FIG. 19 is a schematic diagram showing a configuration of a conventional GTA welding device having a conventional gas supply device.

### DETAILED DESCRIPTION OF THE PREFERRED EMBODIMENTS

Hereinafter, embodiments to which the present invention is applied will be described in detail with reference to the drawings. The drawings used in the following description are for illustrating the configuration of the embodiment of the present invention. Therefore, the sizes, thicknesses, dimensions, etc. of the respective parts shown in the drawings may be different from the actual dimensional relationships of the welding device, the gas supply device, and the gas supply device having a mixing function.

### First Embodiment

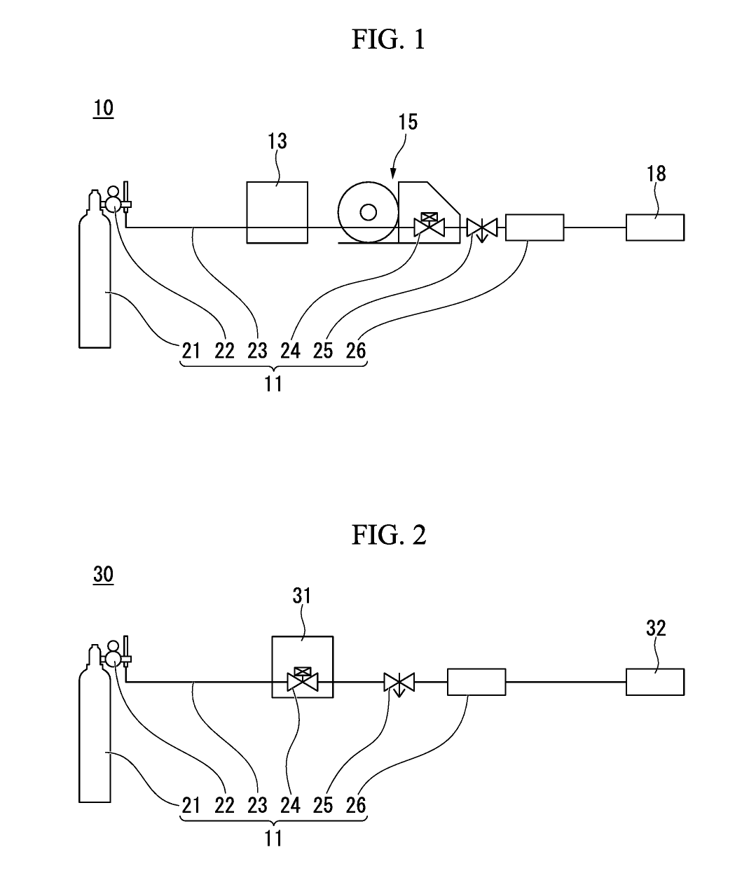

FIG. 1 is a schematic diagram showing a configuration of a welding device according to a first embodiment of the present invention. In FIG. 1, a GMA welding device is illustrated as an example of a welding device including the gas supply device 11.

As shown in FIG. 1, the welding device 10 includes a gas supply device 11, a GMA welding device 13, a wire feeding device 15, a welding torch 18, and a control device (not shown).

The gas supply device 11 includes a gas supply source 21, a single-stage decompressor 22, a gas supply line 23, a solenoid valve 24, a flow regulating valve 25, and a flow meter 26.

The gas supply source 21 is filled with gas at high pressure. As the gas supply source 21, for example, a cylinder filled with a shielding gas at a high pressure (for example, about 15 MPa) can be used. Hereinafter, as an example of the gas supply source 21, a case where a cylinder filled with a shielding gas is used will be described.

The shielding gas can be appropriately selected depending on a workpiece to be welded (not shown). When the material of the workpiece is carbon steel or stainless steel, for example, carbon dioxide gas, a mixed gas of argon and carbon dioxide, a mixed gas of argon and oxygen, a mixed gas of argon, helium, and carbon dioxide, a mixed gas of argon, helium, and oxygen, or the like can be used.

When the material of the workpiece is aluminum or an aluminum alloy, the shielding gas can be selected depending on the thickness of the workpiece, and, for example, argon gas, a mixed gas of argon and helium (a helium-rich mixed gas or an argon-rich mixed gas) or the like can be used.

On the other hand, when the material of the workpiece is stainless steel, a mixed gas of argon and hydrogen, a mixed gas of argon, helium, and hydrogen, a mixed gas of argon and nitrogen, a mixed gas of argon, helium, and nitrogen, or the like can be used.

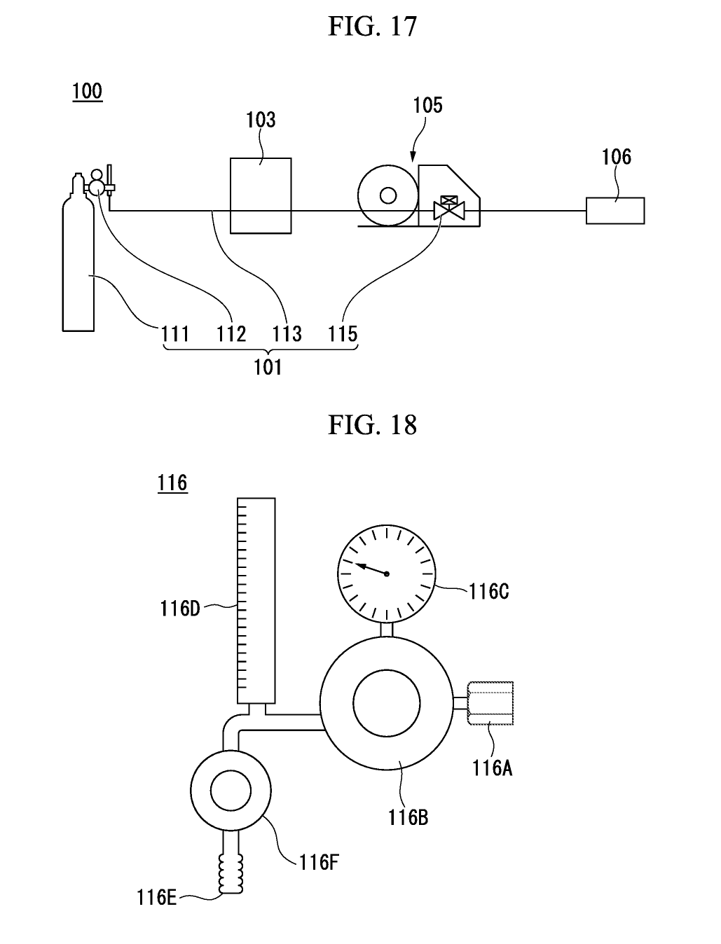

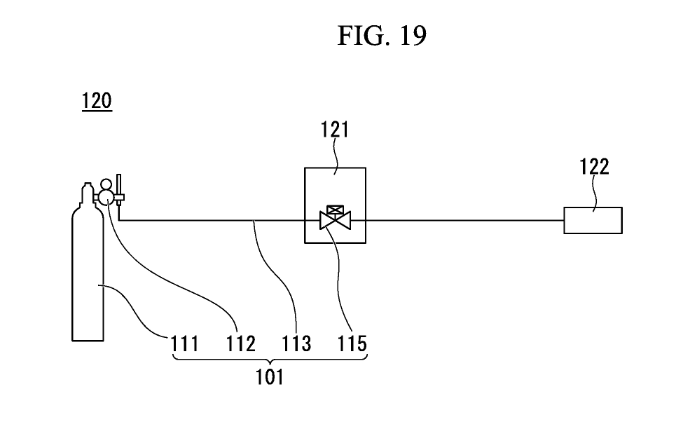

The single-stage decompressor 22 is provided in the gas outlet portion of the gas supply source 21 and is connected to one end of the gas supply line 23. The single-stage decompressor 22 has a simpler structure than the dual-stage decompressor 112 used in the conventional device shown in FIGS. 17 and 19 described above. Therefore, the single-stage decompressor 22 is lower in cost and more maintainable than the dual-stage decompressor 112.

When the pressure in the gas supply source 21 is 15 MPa, the single-stage decompressor 22 reduces the pressure of the shielding gas led out from the gas supply source 21 to about 0.2 MPa, for example.

One end of the gas supply line 23 is connected to the single-stage decompressor 22, and the other end is connected to a welding torch 18 at which the shielding gas is used. The gas supply line 23 is a line for supplying the shielding gas led out from the gas supply source 21 to the welding torch 18.

The solenoid valve 24 is provided in the gas supply line 23 in the wire feeding device 15.

The flow regulating valve 25 is provided in a gas supply line 23 positioned at the latter stage (downstream) of the wire feeding device 15 that accommodates the solenoid valve 24. In other words, the flow regulating valve 25 is provided in the gas supply line 23 located between the solenoid valve 24 and the welding torch 18.

The flow regulating valve 25 may be any valve as long as the flow of the shielding gas can be reduced. As the flow regulating valve 25, for example, a needle valve can be used.

The flow meter 26 is provided in a gas supply line 23 located between the flow regulating valve 25 and the welding torch 18. The flow meter 26 measures the flow of the shielding gas which has passed through the flow regulating valve 25.

The solenoid valve 24 and the flow regulating valve 25 described above are electrically connected to a control device (not shown), and are controlled by the control device (not shown).

The GMA welding device 13 is provided in a gas supply line 23 located between the solenoid valve 24 and the single-stage decompressor 22. The GMA welding device 13 supplies electric power to the wire feeding device and the welding torch via the wire feeding device.

The wire feeding device 15 is provided in a gas supply line 23 located between the flow regulating valve 25 and the GMA welding device 13 so as to accommodate the solenoid valve 24. The wire feeding device 15 supplies a wound wire (not shown) at a predetermined feed rate to the welding torch 18.

The welding torch 18 has a contact tip (not shown). In the welding torch 18, the electricity sent from the GMA welding device 13 is supplied to the wire (not shown) via the contact tip (not shown).

The wire also serves as an electrode and filler metal. An arc is formed from the tip of the wire by the current sent from the contact tip.

From the welding torch 18, the shield gas supplied from the gas supply line 23 is injected to protect the arc from the atmosphere and at the same time the shield gas becomes the arc itself.

Then, the wire is melt by arc plasma, and a droplet is formed at the end of the wire. Then, the droplet receives an external force to detach the end of the wire and moves to the workpiece (base material), whereby the welding is carried out.

A control device (not shown) is electrically connected to the GMA welding device 13, the wire feeding device 15, the solenoid valve 24, the flow regulating valve 25, and the flow meter 26, and performs overall control of the welding device 10.

The control device (not shown) includes a storage unit (not shown) and a control unit (not shown). A program and the like for controlling the welding device 10 and the like are stored in the storage unit. The control unit controls the welding device 10 based on the program stored in the storage unit.

According to the welding device 10 of the first embodiment, because of having the above-described gas supply device 11, it is possible to prevent the rush flow of the shielding gas generated in the initial stage of leading out the shielding gas from the gas supply source 21 (in the initial stage of welding), reduce the cost, and improve the maintenance.

According to the gas supply device 11 of the first embodiment, since the gas supply device 11 includes the flow regulating valve 25 disposed at the latter stage. (downstream) of the solenoid valve 24, when the solenoid valve 24 is closed and opened, it is possible to apply a back pressure to the gas supply line 23 located on the upstream side of the flow regulating valve 25, bring the pressure in the gas supply line 23 located between the single-stage decompressor 22 and the solenoid valve 24 close to the pressure on the outlet side of the single-stage decompressor 22, and thereby reduce the pressure difference.

Since the pressure fluctuation at the time of opening and closing the solenoid valve 24 can be suppressed, it is possible to prevent the shielding gas from rush flowing at the start of welding (in other words, at the start of supplying the shielding gas).

Furthermore, the single-stage decompressor 22 and the flow regulating valve 25 (for example, a needle valve) are lower in cost and have a simpler structure than the dual-stage decompressor 112 used in the conventional device shown FIGS. 17 and 19.

That is, according to the gas supply device 11 of the first embodiment, it is possible to prevent the rush flow of gas generated in the initial stage (at the start of welding) of leading out the shielding gas from the gas supply source 21, and to reduce the cost of the gas supply device 11. In addition,it is also possible to improve the maintenance of the gas supply device 11.

In FIG. 1, a welding device including one gas supply source 21 and one welding torch 18 using the gas is illustrated.

However, in a factory with many welding operations, there may be a case in which one large gas supply source and one single stage decompressor are installed and decompressed gas is supplied to a plurality of gas supply lines.

In such a case, the present invention may be applied to one of the gas supply lines, and the same effects as those explained above of the present invention can be obtained.

For example, the same effect as those explained above can be obtained by installing the GMA welding device 13, the wire feeding device 15, the solenoid valve 24, the flow regulating valve 25, the flow meter 26 and the welding torch 18 in this order from the upstream side of the gas flow in one of the gas supply lines, and when the solenoid valve 24 is opened and closed, applying pressure in the gas supply line located on the upstream side of the flow regulating valve 25 so that the pressure in the gas supply line 23 located between the gas supply source and the solenoid valve 24 is brought close to the pressure of the gas supply source, and reducing the pressure difference.

Moreover, in the first embodiment, the case in which the shielding gas is supplied to the welding torch 18 via only one gas supply line 23 has been described as an example. However, for example, the shield gas may be supplied to the tip of the welding torch 18 by providing at least one gas line (not shown) branched from the gas supply line 23, and supplying the shield gas into the branch gas line. In this case, it is advisable to provide a check valve (not shown) in the branch gas line.

In this way, by providing the check valve in the branch gas line, even when the line for supplying the shielding gas is switched while the arc is generated, since the distance between the tip of the torch and the check valve is short, the gas can be switched quickly, and the turbulence of the arc can be suppressed by the rush flow prevention function.

Further, in the first embodiment, as an example, the case in which the pressure inside the gas supply source 21 is high has been described. However, when the pressure inside the gas supply source 21 is low (for example, in a range of 0.1 to 1.0 MPa), it is possible to prevent the gas from rush flowing.

Further, in the gas supply device 11 of the first embodiment, by increasing the distance between the solenoid valve 24 and the flow regulating valve 25, it is possible to lengthen the flowing time of the residual gas when the solenoid valve 24 is closed.

In this way, by increasing the distance between the solenoid valve 24 and the flow regulating valve 25 so as to lengthen the flowing time of the residual gas when the solenoid valve 4 is closed, it is possible to lengthen the time of afterflow after the welding is finished, and thereby the oxidation of electrode (not shown) constituting the welding torch 18 can be suppressed.

In the case of switching the shielding gas during the occurrence of the arc, it is preferable to provide at least one branch gas line (not shown) branched from the gas supply line 23. Since the flow of the shielding gas is not interrupted, oxidation of the electrode can be further suppressed.

Next, referring to FIG. 1, the gas supply method of the first embodiment in the case of using the welding device 10 shown in FIG. 1 will be described.

The gas supply method of the first embodiment includes a decompression step in which the pressure of the shield gas is reduced by using the single-stage decompressor 22 so that the pressure of the shielding gas led out from the gas supply source 21 filled with the shielding gas at high pressure becomes a predetermined pressure; and a back pressure applying step in which when the solenoid valve 24 is opened and closed, which is provided in the gas supply line 23 of which one end is connected to the single-stage decompressor 22 and the other end is connected to the welding torch 18 (use destination) of the shielding gas, a hack pressure is applied in the gas supply line 23 positioned on the upstream side of the flow regulating valve 25 by the flow regulating valve 25 disposed at the latter stage of the solenoid valve 24.

According to the gas supply method of the first embodiment, by applying the hack pressure to the gas supply line 23 positioned on the upstream side of the flow regulating valve 25 at the time of opening and closing the solenoid valve 24, it is possible to close the pressure of the gas supply line 23 between the single-stage decompressor 22 and the solenoid valve 24 to the pressure on the outlet side of the single-stage decompressor 22, thereby the pressure difference can be reduced.

That is, since the pressure fluctuation at the time of opening and closing the solenoid valve 24 can be suppressed, it is possible to prevent the shielding gas from rush flowing in the initial stage of welding.

Further, the single-stage decompressor 22 and the flow regulating valve 25 (for example, a needle valve) are lower in cost and have a simpler structure than the dual-stage decompressor 112 used in the conventional device shown in FIGS. 17 and 19.

That is, according to the gas supply device gas and the gas supply method of the first embodiment, it is possible to prevent the shield gas from rush flowing in the initial stage (the initial stage of welding) of leading out the shielding gas from the gas supply source 21. In addition, the cost of the gas supply device 11 can be reduced and the maintenance of the gas supply device 11 can be improved.

### Second Embodiment

FIG. 2 is a schematic diagram showing a configuration of a welding device according to a second embodiment of the present invention. In FIG. 2, a GTA welding device is illustrated as an example of the welding device 30 including the gas supply device 11.

As shown in FIG. 2, the welding device 30 of the second embodiment has the same structure as that of the welding device 10 of the first embodiment, except that the welding device 30 includes a GTA welding device 31, and a welding torch 32 instead of the GMA welding device 13, the wire feeding device 15, and the welding torch 18 of the GTA welding device 31, and the arrangement of the solenoid valve 24 is different.

The GTA welding device 31 is provided in the gas supply line 23 located between the solenoid valve 24 and the single-stage decompressor 220 The GTA welding device 31 supplies electric power to a tungsten electrode of the welding torch 18.

The shielding gas of the GTA welding device 31 can be appropriately selected depending on the material constituting the workpiece to be welded (not shown). When the material of the workpiece is a metal such as carbon steel, aluminum, an aluminum alloy, copper, a copper alloy, etc., for example, single gas of argon, a mixed gas of argon and helium, or the like can be used as the shield gas.

On the other hand, when the material of the workpiece is stainless steel, examples of the shielding gas include a mixed gas of argon and hydrogen, a mixed gas of argon, helium and hydrogen, a mixed gas of argon and nitrogen, a mixed gas of argon, helium, and nitrogen.

The solenoid valve 24 is provided in the gas supply line 23 inside the GTA welding device 31.

The welding torch 32 is a welding torch for GTA welding and is connected to the other end of the gas supply line 23.

Since the welding device 30 (GTA welding device) of the present embodiment has the same gas supply device 11 as that included in the welding device 10 of the first embodiment, the same effects as those of the welding device 10 of the first embodiment can be obtained.

In addition, since the gas supply method of the second embodiment using the welding device 30 can be performed by the same procedure as that of the gas supply method described in the first embodiment, the same effects as those of the gas supply method of the first embodiment can be obtained.

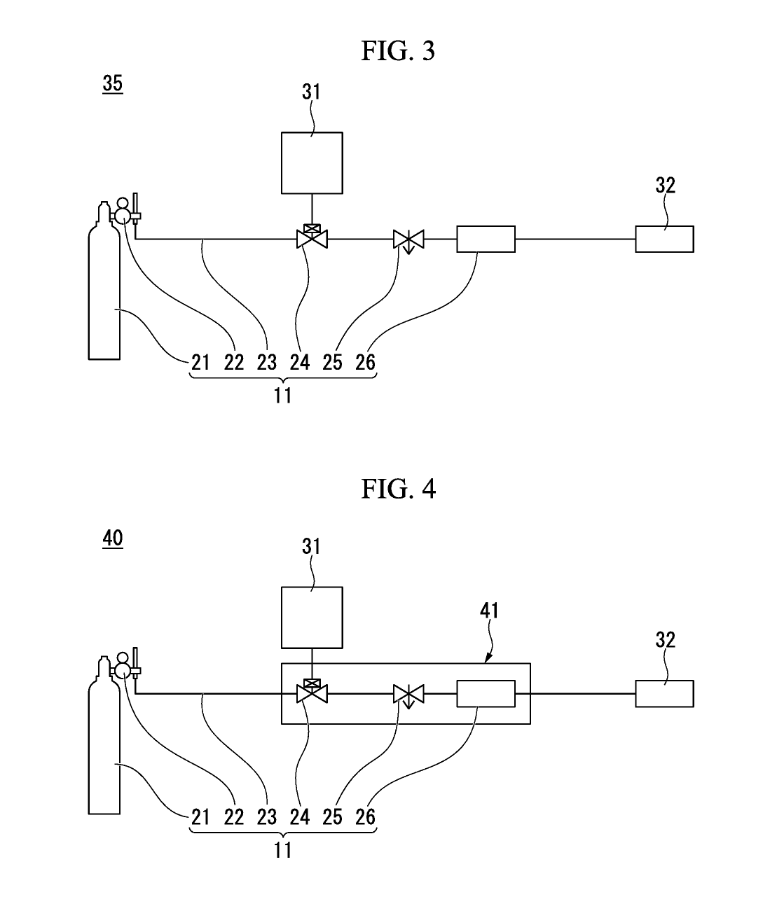

FIG. 3 is a schematic diagram showing a configuration of a welding device according to a first modification of the second embodiment of the present invention. In FIG. 3, the same reference numerals are attached to the same components as those of the welding device 30 of the second embodiment shown in FIG. 2.

As shown in FIG. 3, the welding device 35 of the first modification of the second embodiment has the same structure as that of the welding device 30, except that the GTA welding device 31 of the welding device 30 of the second embodiment is disposed outside the solenoid valve 24 and the opening and closing of the solenoid valve 24 can be controlled by the GTA welding machine 31.

Even in the welding device 35 having such a structure, the same effects as those of the welding device 30 of the second embodiment having the gas supply device 11 can be obtained.

Further, in the welding device 35 of this modified embodiment, since the solenoid valve 24 is installed independently, maintenance of the solenoid valve 24 can be easily performed.

FIG. 4 is a schematic diagram showing a configuration of a welding device according to a second modification of the second embodiment of the present invention. In FIG. 4, the same reference numerals are attached to the same components as those of the welding device 35 according to the first modification of the second embodiment shown in FIG. 3.

As shown in FIG. 4, the welding device 40 according to the second modification of the second embodiment has the same structure as that of the welding device 35 according to the first modification of the second embodiment, except that the solenoid valve 24, the flow regulating valve 25, and the flow meter 26, which constitute the welding device 35 are collectively set as an electromagnetic valve control device 41,

Since the welding device 40 having such a structure also has the gas supply device 11, the same effects as those of the welding device 35 according to the first modification of the second embodiment can be obtained.

### Third Embodiment

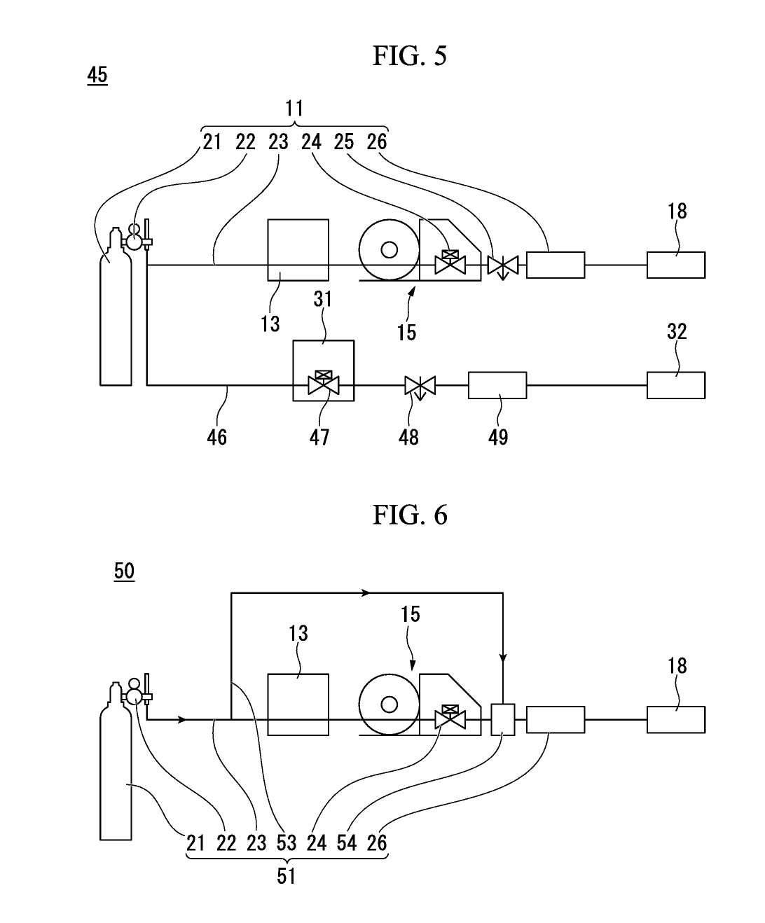

FIG. 5 is a schematic diagram showing a configuration of a welding device according to a third embodiment of the present invention. In FIG. 5, the same reference numerals are attached to the same components as those of the welding device shown in FIGS. 1 and 2 (specifically, the welding devices 10, 30).

As shown in FIG. 5, the welding device 45 of the third embodiment has the same structure as that of the welding device 10 of the first embodiment except that the welding device 45 further includes a GTA welding device 31, a welding torch 32, a branch line 46 (second branch line), a solenoid valve 47 (the other solenoid valve), a flow regulating valve 48 (the other flow regulating valve), and a flow meter 49.

The branch line 46 is branched from the gas supply line 23 located between the single-stage decompressor 22 and the GMA welding device 13, and is connected to the welding torch 32.

The solenoid valve 47 is provided in the branch line 46 and accommodated in the GTA welding device 31.

The flow regulating valve 48 is provided in the branch line 46 located at the latter stage of the solenoid valve 47. As the flow regulating valve 48, for example, the same one as the flow regulating valve 25 described above can be used.

The GTA welding device 31 is configured to control the solenoid valve 47.

According to the welding device 45 of the third embodiment as described above, it is possible to perform two types of welding of GMA welding and GTA welding, and prevent the rush flow of the shield gas generated in die initial stage of lead-out from the gas supply source 21 (in the initial stage of welding).

In addition, it is possible to reduce the cost of the gas supply device 11 and to improve the maintenance of the gas supply device 11.

The welding method of the third embodiment using the welding device 45 can be carried out in the same manner as that in the second embodiment except that either the gas supply line 23 or the branch line 46 is selected as the line: for supplying the shielding gas. The welding method of the third embodiment can obtain the same effects as those of the welding method in the second embodiment.

### Fourth Embodiment

FIG. 6 is a schematic diagram showing a configuration of a welding device according to a fourth embodiment of the present invention. In FIG. 6, the same reference numerals are attached to the same components as those of the welding device 10 shown in FIG. 1.

As shown in FIG. 6, the welding device 50 of the fourth embodiment has the same structure as that of the welding device 10 of the first embodiment except that the gas supply device 51 is used instead of the gas supply device 11.

The gas supply device 51 has the same structure as that of the gas supply device 11 except that the gas supply device 51 includes a branch line 53 (first branch line) and a constant flow valve 54 instead of the flow regulating valve 25

The branch line 53 is branched from h gas supply line 23 positioned at a former stage of the solenoid valve 24 and the GMA welding device 13, and is connected to the constant flow valve 54.

The constant flow valve 54 is provided in the gas supply line 23 located between the solenoid valve 24 and the flow meter 26. The constant flow valve 4 has a function of changing the supply amount of the shielding gas to he supplied to the flow in accordance with the pressure on the upstream side of the gas supply line 23 transmitted to the constant flow valve 54 via the branch line 53.

The constant flow valve 54 has a mechanism for maintaining a preset gas flow. When the pressure on the upstream side of the gas supply line 23 becomes high, the diameter of the flow path for supplying the gas to the flow meter 26 side is made small, and when the pressure on the upstream side of the gas supply line 23 becomes low, the diameter of the flow path is made large.

As the constant flow valve 54, for example, a flow control valve, a flow regulating valve, or the like can be used.

According to the gas supply device 51 of the fourth embodiment, as described above, by including the branch line 53 and the constant flow valve 54, when the solenoid valve 24 is opened and closed, a back pressure is applied to the gas supply line 23 located on the upstream side of the constant flow valve 54 by the constant flow valve 54 in accordance with the pressure of the gas supply line 23 located on the upstream side of the constant flow valve 54. The pressure in the gas supply line 23 located between the single-stage decompressor 22 and the solenoid valve 24 can be brought close to the pressure on the outlet side of the single-stage decompressor 22, and the pressure difference can be reduced.

Thereby, since the pressure fluctuation at the time of opening and closing the solenoid valve 24 can be suppressed, it is possible to prevent the shielding gas from rush flowing at the start of welding (in other words, at the start of supplying the shielding gas).

In addition, the single-stage decompressor 22 and the constant flow valve 54 (for example, a flow control valve and a flow regulating valve) are lower in cost and have a simpler structure than the dual-stage decompressor 112 used in the conventional device shown in FIGS. 17 and 19.

That is, according to the gas supply device 51 of the fourth embodiment, it is possible to prevent the shield gas from rush flowing in the initial stage (at the start of welding) of leading out the shielding gas from the gas supply source 21. In addition, it is possible to reduce the cost of the gas supply device 11, and the maintenance of the gas supply device 51 can be also improved.

Further, the welding device 50 having the gas supply device 51 can obtain the same effects as those of the gas supply device 51.

In addition, the gas supply device 51 can supply the shielding gas by the same method (gas supply method) as that of the gas supply device 11 described in the first embodiment.

In FIG. 6, as an example of the branching position of the branch line 53, the case in which the branch line 53 is branched from the gas supply line 23 positioned between the single-stage decompressor 22 and the GMA welding machine H. However, the branching position of the branch line 53 is not limited to the branching position as shown in FIG. 6 as long as the branching position is the former stage of the solenoid valve 24.

Further, in the fourth embodiment, the case in which the shielding gas is supplied to the welding torch 18 via only one gas supply line 23 has been described as an example. However, for example, it is also possible to provide at least one branch gas line (not shown) branched from the gas supply line 23 and supply the shield gas to the tip of the welding torch 18 via the branch gas line. In this case, it is preferable to provide a check valve (not shown) in the branch gas line.

In this way, by providing the check valve in the branch gas line, even when the line for supplying the shielding gas is switched while the arc is generated, since the distance between the tip of the torch and the check valve is short, the gas can be switched quickly, and turbulence of the arc can be suppressed by the rush flow prevention function.

Further, in the fourth embodiment, as an example, the case in which the pressure inside the gas supply source 21 is high has been described. However, when the pressure inside the gas supply source 21 is low (for example, in a range of 0.1 to 1.0 MPa), it is possible to prevent the gas from rush flowing.

Further, in the gas supply device 51 of the fourth embodiment, by increasing the distance between the solenoid valve 24 and the constant flow valve 54, it is possible to lengthen the flowing time of the residual gas when the solenoid valve 24 is closed.

In this way, by increasing the distance between the solenoid valve 24 and the constant flow valve 54 so as to lengthen the flowing time of the residual gas when the solenoid valve 24 is closed, it is possible to lengthen the time of afterflow after the welding is finished, and thereby the oxidation of electrode (not shown) constituting the welding torch 18 can be suppressed

In particular, when at least branch gas line (not shown) branched from the gas supply line 23 is provided and the shielding gas is switched during the arc generation, the flow of the shielding gas is not interrupted. Accordingly, the oxidation of the electrode can be suppressed.

### Fifth Embodiment

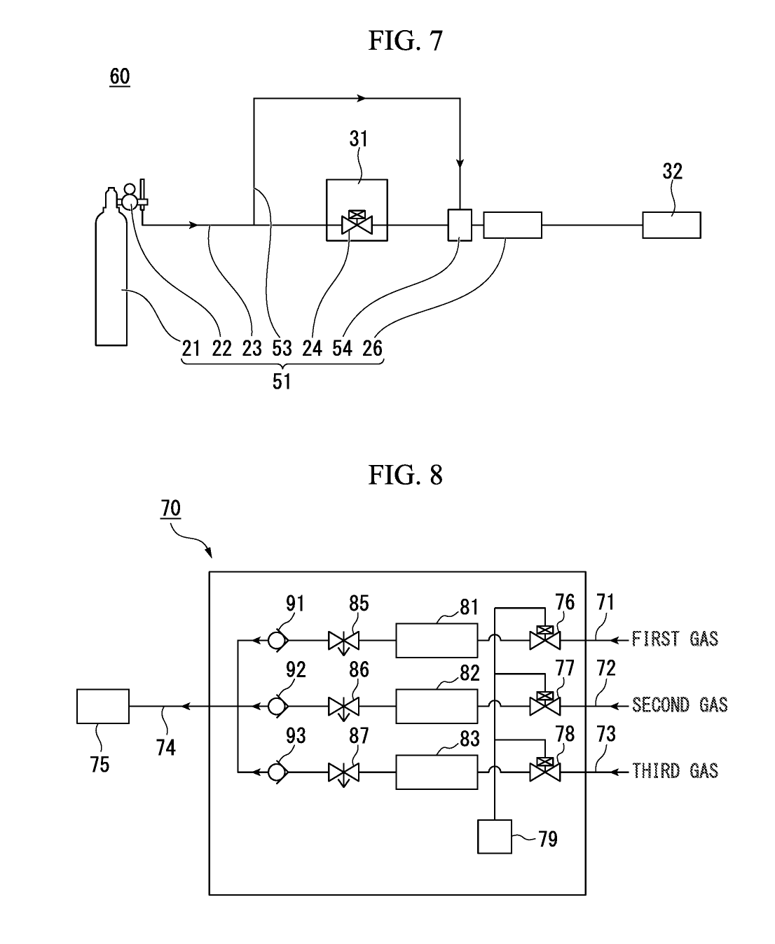

FIG. 7 is a schematic diagram showing a configuration of a welding device according to a fifth embodiment of the present invention. In FIG. 7, the same reference numerals are attached to the same components as those of the structures shown in FIGS. 2 and 6 (specifically, the welding devices 30, 50).

As shown in FIG. 7, the welding device 60 of the fifth embodiment has the same structure as that of the welding device 30 of the second embodiment except that the gas supply device 51 described with reference to FIG. 6 is used instead of the gas supplying device 11.

The welding device 60 of the fifth embodiment having such a structure can obtain the same effects as those of the welding device 50 of the fourth embodiment.

Although the preferred embodiments of the present invention have been described in detail, the present invention is not limited to such specific embodiments, and various modifications and changes can be made within the scope of the gist of the present invention described in the claims.

For example, instead of the gas supply device 11 constituting the welding devices 35, 40, 45 shown in FIGS. 3, 4, and 5, the gas supply device 51 shown in FIGS. 6 and 7 may be used.

Further, in the welding device 45 shown in FIG. 5, the gas supply device 11 and the gas supply device 51 may be used.

In the first to fifth embodiments, as an example, the case in which the gas supply device 11 or the gas supply device 51 is used in the welding devices 10, 30, 35, 40, 45, 50, and 60 has been described. However, the gas supply devices 11 and 51 may be used to supply gas in fields other than welding.

Specifically, the gas supply devices 11 and 51 can be used in combination with other devices having problems in gas flow, such as a gas mixer.

FIG. 8 is a diagram showing an example of a gas supply device having a mixing function which can use three types of shielding gas.

As shown in FIG. 8, the gas supply device 70 having a mixing function includes a first shield gas supply line 71 for supplying a first shield gas, a second shield gas supply line 72 for supplying a second shield gas, a third shield gas supply line 73 for supplying a third shielding gas, solenoid valves 76 to 78, a solenoid valve control unit 79, flow meters 81 to 83, doll valves 85 to 87, check valves 91 to 93, and a single-stage decompressor (not shown).

One end of the first shield gas supply line 71 is connected to a first shield gas supply source (not shown) for supplying the first shield gas, and the other end is connected to one end of the line 74. One end of the second shield gas supply line 72 is connected to a second shield gas supply source (not shown) for supplying the second shield gas, and the other end is connected to one end of the line 74. One end of the third shield gas supply line 73 is connected to a third shield gas supply source (not shown) for supplying the third shield gas, and the other end is connected to one end of the line 74.

The solenoid valve 76, the flow meter 81, the needle valve 85, and the check valve 91 are provided in the first shield gas supply line 71. The solenoid valve 76, the flow meter 81, the needle valve 85, and the check valve 91 are disposed in this order with respect to the direction from the first shielding gas supply source (not shown) to the line 74.

The solenoid valve 77, the flow meter 82, the needle valve 86, and the check valve 92 are provided in the second shield gas supply line 72. The solenoid valve 77, the flow meter 82, the needle valve 86, and the check valve 92 are disposed in this order with respect to the direction from the second shielding gas supply source (not shown) to the line 74.

The solenoid valve 78, the flow meter 83, the needle valve 8′7, and the check valve 93 are provided in the third shield gas supply line 73. The solenoid valve 78, the flow meter 83, the needle valve 87, and the check valve 93 are disposed in this order with respect to the direction from the third shielding gas supply source (not shown) to the line 74. A gas mixer (not shown) may be provided at the intersection of the first to third shield gas supply lines 71 to 73.

The solenoid valves 76 to 78 are electrically connected to the solenoid valve control unit 79. The other end of the line 74 is connected to the welding torch 75. The solenoid valve control unit 79 performs opening and closing control of the solenoid valves 76 to 78.

The line 74 functions as a gas mixing portion for mixing together at least two types of the shielding gas. It is also possible to supply only one type of the shielding gas.

A single-stage decompressor (not shown) is provided respectively with the first shield gas supply line 71 located in the former stage of the solenoid valve 76, the second shield gas supply line 72 located in the former stage of the solenoid valve 77, and the third shield gas supply line 73 located in the former of the solenoid valve 7.

That is, the gas supply device having a mixing function 70 is configured to include a plurality of gas supply devices including the shield gas supply line, the solenoid valve, the flow meter, the needle valve, and the check valve.

By using the gas supply device 70 having a mixing function as described above, it is possible to change the type of the shielding gas to be supplied to the welding torch 75 or mix the shielding gas to a desired composition depending on the welding target and welding timing. In addition, a buffer tank may be attached to the line 74 before the welding torch 75.

The solenoid valve control unit 79 performs opening and closing control of the solenoid valves 76 to 78 with a manual operation (switch), a wiring operation for an existing installation, a current sensor using a magnetic core, or the like. In particular, in the case of using a split type current sensor or a clamp type current sensor, it is possible to sense the presence or absence of current in a wiring for controlling another existing valve, or a wiring for controlling a welding robot, and control the opening and closing of the solenoid valves 76 to 78 used in the device using the shield gas mixer in accordance with the presence or absence of the current (that is, the movement of valves or the like controlled by the current) without requiring expert knowledge.

In the first to fifth embodiments and FIG. 8, as an example, the case in which the shield gas is supplied has been described. However, a pilot gas may be supplied around the electrode constituting the welding torches 18, 32, and 75, and the shielding gas may be supplied to shield the welded portion from the atmosphere at the same time.

In this case, it is necessary to provide a pilot gas supply source for supplying the pilot gas instead of the shield gas supply source, and a pilot gas supply line for flowing the pilot gas instead of the shield gas supply line. The present invention can also be applied to supply of such pilot gas, and the above-mentioned effects can be expected.

Hereinafter, experimental examples will be described, but the present invention is not limited to the following experimental examples.

### EXPERIMENTAL EXAMPLE 1

### EXAMPLE 1 AND COMPARATIVE EXAMPLE 1

Using the welding device 10 shown FIG. 1 (hereinafter referred to as “Example 1”) and the welding device 100 shown in FIG. 17 (hereinafter referred to as “Comparative Example 1”), the pressure fluctuations in the shield gas supply lines 23, 113 when the shield gas supplied were investigated.

The pressure fluctuation is determined by installing a digital pressure gauge in the shield gas supply line 23 between the shield gas supply source 21 and the solenoid valve 24 (upstream side) and the shield gas supply line 113 between the shield gas supply source 111 and the solenoid valve 115 (upstream side), respectively, and observing the change in pressure.

At this time, the pressure on the outlet side (exit side) of the shielding gas supply sources 21 and 111 when the flow of the shielding gas is 20 L/min was set to 0.2 MPa and the pressure on the outlet side (exit side) of the shielding gas supply sources 21 and 111 when the flow of the shielding gas is 5 L/min was set to 0.22 MPa

The inner diameter of the shielding gas supply lines 23, 113 was ϕ6 mm. The length of the shield gas supply line 23 located between the shield gas supply source 21 and the solenoid valve 24 and the length of the shield gas supply line 113 located between the shield gas supply source 111 and the solenoid valve 115 was set to 5,000 mm.

The length of the shielding gas supply line 23 located between the solenoid valve 24 and the flow regulating valve 25 was 300 mm.

As the flow regulating valve 25, a needle valve (JNMU 6 (model number) manufactured by Pisco Corporation was used.

As a result, in Comparative Example 1, the pressure when the flow of the shielding gas was 20 L/min varied in the range of 0.04 to 0.22 MPa and the pressure fluctuation range was 0.18 MPa.

On the other hand, in Example 1, the pressure when the flow of the shielding gas was 20 L/min varied in the range of 0.2 to 0.23 MPa, and the pressure fluctuation range. was 0.03 MPa.

In Comparative Example 1, the pressure when the flow of the shielding gas was 5 L/min varied in the range of 0.01 to 0.22 MPa, and the pressure fluctuation range was 0.21 MPa.

On the other hand, in Example 1, the pressure when the flow of the shielding gas was 20 L/min varied in the range of 0.22 to 0.23 MPa, and the pressure fluctuation range was 0.01 MPa.

From the results above, it was confirmed that, in Example 1, the pressure fluctuation range can be reduced to about 1/21 to 1/6 of the pressure fluctuation range of Comparative Example 1 without depending on the supply amount of the shielding gas.

Further, it was confirmed that, in Example 1, the flow of the shield gas increases sooner when the solenoid valve is opened, and the flow of the shield gas decreases sooner when the solenoid valve is closed compared with Comparative Example 1.

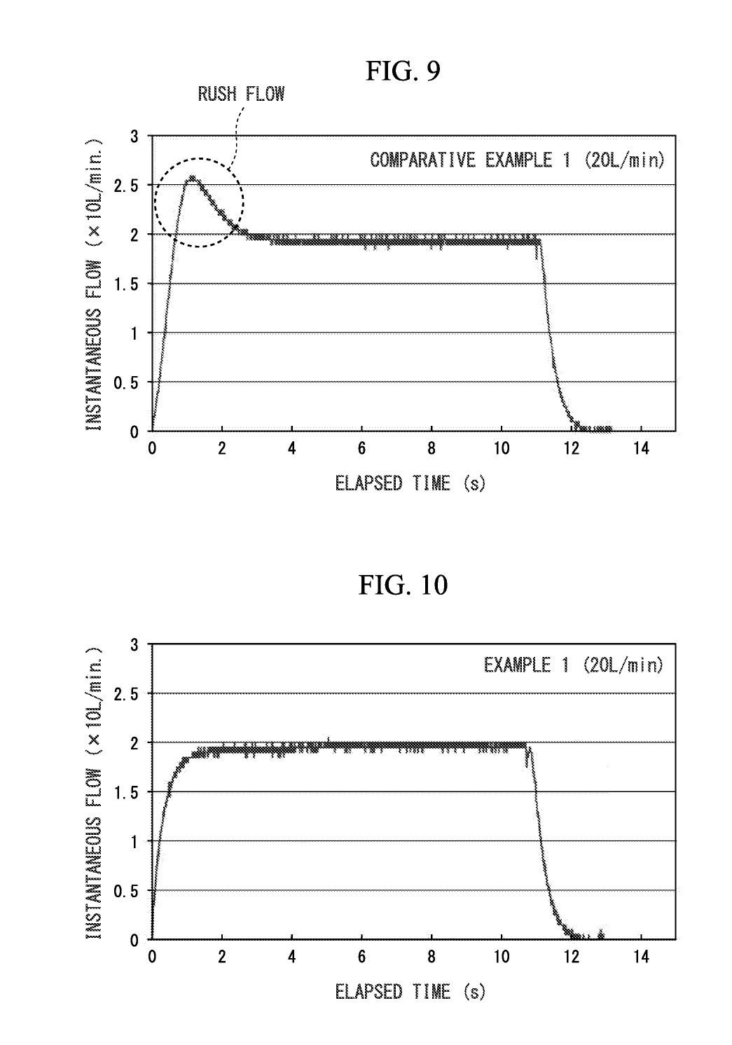

Next, under the above conditions, fluctuations in the flow of the shielding gas when the solenoid valves 24 and 115 are opened were examined using a mass flow meter (CMS0050 (model number) manufactured by Azbil). The results are shown in FIGS. 9 to 12.

FIG. 9 is a graph showing the relationship between the instantaneous flow and the elapsed time when the flow of the shielding gas is 20 L/min and the pressure setting on the outlet side (outlet side) of the gas supply source is 0.2 MPa in Comparative Example 1.

FIG. 10 is a graph showing the relationship between the instantaneous flow and the elapsed time when the flow of the shielding gas is 20 L/min and the pressure setting on the outlet side (exit side) of the gas supply source is 0.2 MPa in Example 1.

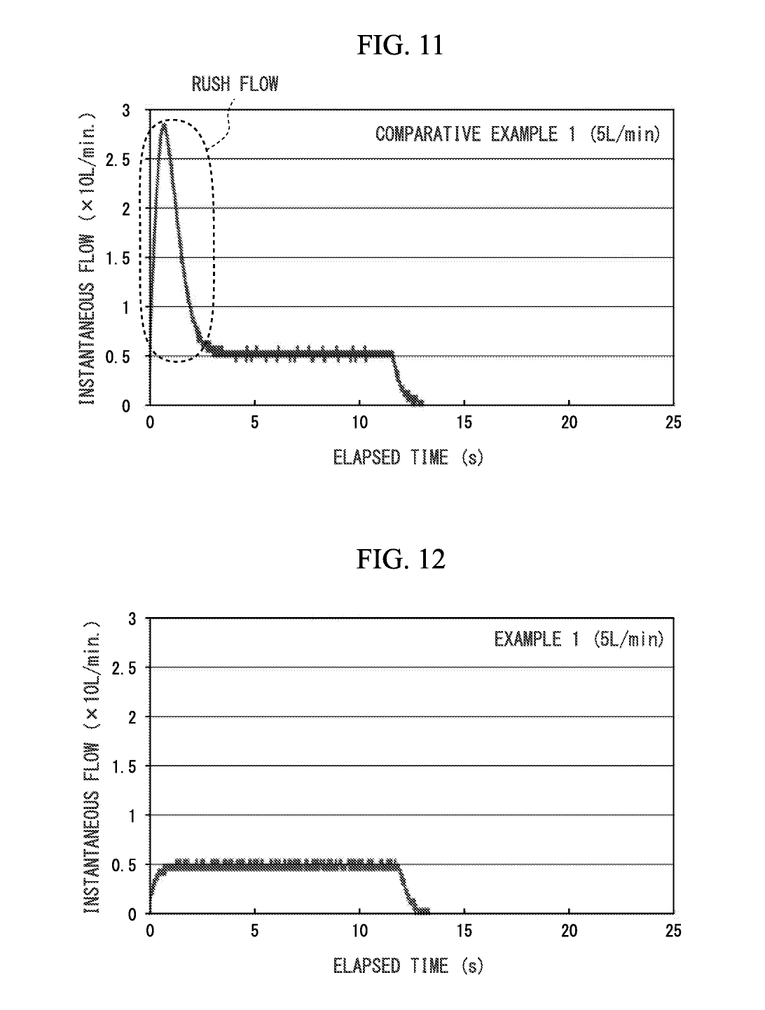

FIG. 11 is a graph showing the relationship between the instantaneous flow and the elapsed time when the flow of the shielding gas is 5 L/min and the pressure setting on the outlet side (exit side) of the gas supply source is 0.22 MPa in Comparative Example 1.

FIG. 12 is a graph showing the relationship between the instantaneous flow and the elapsed time when the flow of the shielding gas is 5 L/min and the pressure setting on the outlet side (exit side) of the gas supply source is 0.22 MPa in Example 1.

The “instantaneous flow” shown in FIGS. 9 to 12 refers to the flow of gas instantaneously flowing when the solenoid valve is opened. Then, the flow of gas instantaneously generated when the solenoid valve is opened is called rush flow.

As shown in FIGS. 9 to 12, it was confirmed that, in Comparative Example 1, a rush flow occurred after the start of supply of the shielding gas in spite of the magnitude of the flow of the shielding gas. In addition, it was confirmed from the results in FIGS. 9 and 12 that the rush flow becomes large when the flow of the shielding gas is small.

On the other hand, it was confirmed that, in Example 1, no rush flow occurred after the start of supply of the shielding gas in spite of the magnitude of the flow of the shielding gas.

### EXAMPLE 2

The pressure fluctuation in the shield gas supply line 23, and the relationship between the instantaneous flow and the elapsed time when the shielding gas was supplied were examined under the same conditions as those described above except that only the pressure on the outlet side (exist side) of the shielding gas supply source 21 when the flow of the shielding gas was 5 L/min was changed from 0.22 MPa to 0.7 MPa.

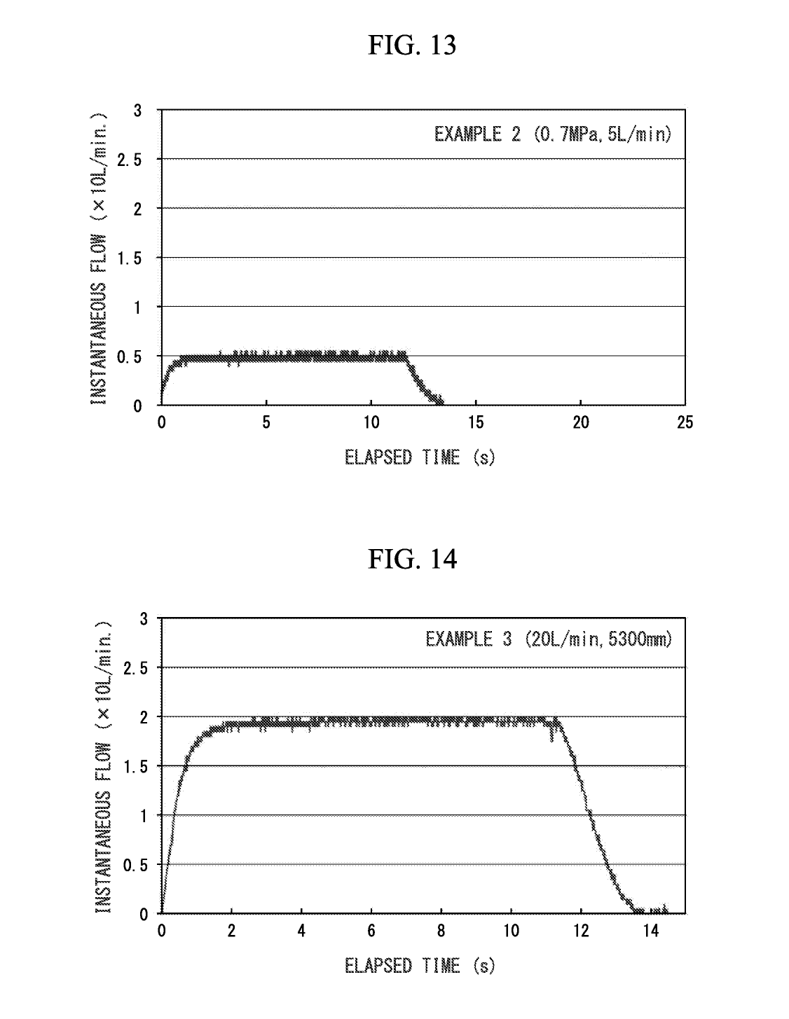

FIG. 13 shows the relationship between the instantaneous flow and the elapsed time when the flow of the shielding gas is 5 L/min and the pressure setting on the outlet side (exit side) of the shielding gas supply source is 0.7 MPa.

The pressure was 0.7 to 0.71 MPa, and the pressure fluctuation range was 0.01 MPa. Moreover, even when the flow of the shielding gas was changed from 5 L,/min to 20 L/min, the pressure was 0.7 to 0.71 MPa and the pressure fluctuation range was 0.01 MPa.

As shown in FIG. 13, it was confirmed that even when the pressure at the outlet side (exit side) of the shielding gas supply source 21 was increased, there was no rush flow of the shielding gas.

### EXPERIMENTAL EXAMPLE 2

### EXAMPLE 3

The data showing the relationship between the instantaneous flow and the elapsed time was obtained under the same conditions (the flow of the shielding gas: 20 L/min, the pressure setting at the outlet side (exist side) of the shielding gas supply source: 0.2 MPa) as those when the data shown in FIG. 10 was obtained except that the length of the shielding gas supply line 23 located between the solenoid valve 24 and the flow regulating valve 25 was changed from 300 mm to 5,300 mm. The result is shown in FIG. 14. In the case of FIG. 10 (when the length of the shielding gas supply line 23 positioned between the solenoid valve 24 and the flow regulating valve 25 is 300 mm), the time from hen the solenoid valve 24 is opened until when the flow of the shielding gas becomes stable was 2 seconds. The time from when the solenoid valve was closed until when the residual gas disappeared was 1.9 seconds.

Note that the “residual gas” means the gas remaining in the shield gas supply line 23.

As shown in FIG. 14, in Example 3, the time from when the solenoid valve was opened until when the flow of the shielding gas becomes stable was 2 seconds. The time from when the solenoid valve was closed until when the residual gas disappeared was 0.8 seconds.

In addition, in Example 3, the rush flow of the shielding gas was not confirmed.

### EXAMPLE 4

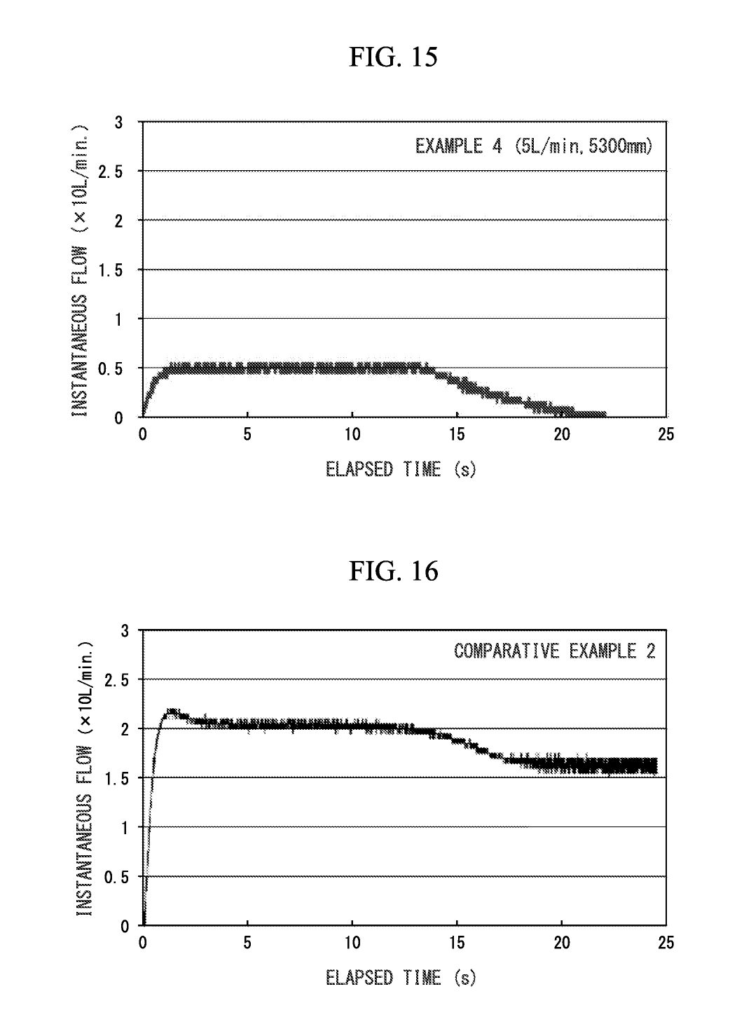

The data showing the relationship between instantaneous flow and the elapsed time was obtained under the same conditions (the flow of the shielding gas: 5 L/min, the pressure setting at the outlet side (exist side) of the shielding gas supply source: 0.22 MPa) as those when the data shown in FIG. 12 was obtained except that the length of the shielding gas supply line 23 located between the solenoid valve 24 and the flow regulating valve 25 was changed from 300 mm to 5,300 mm. The result is shown in FIG. 15.

In the case of FIG. 12 (when the length of the shielding gas supply line 23 positioned between the solenoid valve 24 and the flow regulating valve 25 is 300 mm), the time from when the solenoid valve 24 is opened until when the flow of the shielding gas becomes stable was 0.85 seconds. The time from when the solenoid valve closed until when the residual gas disappeared was 0.6 seconds.

On the other hand, in Example, 4 as shown in FIG. 18, the time from when the solenoid valve 24 is opened until when the flow of the shielding gas becomes stable was 0.85 seconds. The time from when the solenoid valve was closed until when the residual gas disappeared was 7 seconds.

From these results, it was confirmed that when the length of the shielding gas supply line 23 located between the solenoid valve 24 and the flow regulating valve 25 becomes longer, the time from when the solenoid valve 24 is closed until when the amount of the residual gas becomes zero becomes longer.

In Example 4, the rush flow of the shielding gas was not confirmed.

### COMPARATIVE EXAMPLE 2

The data showing the relationship between instantaneous flow and elapsed time was obtained under the same conditions (the flow of the shielding gas: 20 L/min, the pressure setting at the outlet side (exist side) of the shielding gas supply source: 0.2 MPa) as those when the data shown in FIG. 10 was obtained except that the mass flow controller (CMS0050 (model number) manufactured by Azhil was used instead of the flow regulating valve 25 of the welding device 10 shown in FIG. 1. The result is shown in FIG. 16.

As shown in FIG. 16, it was confirmed that when the mass flow controller was used, the flow of the shielding gas was not stabilized for 18 seconds from the start.

### INDUSTRIAL APPLICABILITY

The present invention is applicable to a gas supply device that supplies a shielding gas to a use destination, a gas supply device having a mixing function including a plurality of gas supply devices, a welding device, and a gas supply method.

### EXPLANATION OF REFERENCE NUMERAL

10, 30, 35, 40, 45, 50, 60 welding device

11, 51 gas supply device

13 GMA welding device

15 wire feeding device

18, 32 welding torch

21 shielding gas supply source

22 single-stage decompressor

23 shield gas supply line

24, 47 solenoid valve

25, 48 flow regulating valve

26, 49 flow meter

31 GTA welding device

41 solenoid valve control device

46, 53 branch line

54 constant flow valve

70 gas supply device having a mixing function

71 first shield gas supply line

72 second shield gas supply line

73 third shield gas supply line

76 to 78 solenoid valve

79 solenoid valve control unit

74 line

75 welding torch

76 to 78 solenoid valve

79 solenoid valve control unit

81 to 83 flow meter

85 to 87 needle valve

91 to 93 check valve

1. A gas supply device comprising:
a gas supply source into which a gas is filled at a high pressure,
a single-stage decompressor which is provided at a gas outlet of the gas supply source and which is configured to reduce pressure of a gas led out from the gas supply source to a predetermined pressure,
a gas supply line having one end connected to the single-stage decompressor and the other end connected to a use destination of the gas,
a solenoid valve provided in the gas supply line, and
a flow regulating valve provided in the gas supply line located between the solenoid valve and the use destination.

2. The gas supply device according to claim 1, wherein the gas supply device comprises a constant flow valve provided in the gas supply line located in a latter stage of the solenoid valve instead of the flow regulating valve, and a first branch line which is branched from the gas supply line located in a former stage of the solenoid valve and connected to the constant flow valve.

3. The gas supply device according to claim 1, wherein the flow regulating valve is a needle valve.

4. The gas supply device according to claim 1, wherein the gas supply device further includes a flow meter which is provided in the gas supply line located in a latter stage of the flow regulating valve and measures the flow of the gas.

5. The gas supply device according to claim 1, wherein the gas supply device comprises a pilot gas supply source which is configured to supply a pilot gas instead of the shield gas supply source, and a pilot gas supply line in which the pilot gas flows instead of the shield gas supply line.

6. A gas supply device having a mixing function comprising a plurality of gas supply devices according to claim 1, and a line which has one end connected to each shield gas supply line in the plurality of gas supply device and the other end connected to the use destination, and has a function of mixing together a plurality of the shield gases.

7. The gas supply device having a mixing function according to claim 6, wherein the gas supply device having a mixing function further includes a solenoid valve control unit which is electrically connected to the solenoid valve in the plurality of gas supply device and is configured to control the solenoid valve, and the solenoid valve control unit is a current sensor which uses a magnetic core.

8. A welding device including the gas supply device according to claim 1, the use destination is a welding torch, and the gas supply device is configured to supply the shielding gas.

9. A welding device comprising:
the gas supply device according to claim 1;
a GMA welding device provided in the shield gas supply line located between the solenoid valve and the single-stage decompressor;
a second branch line branched from the shield gas supply line located between the single-stage decompressor and the GMA welding device,
another solenoid valve provided in the second branch line;
another flow regulating valve provided in the second branch line located at the latter stage of the other solenoid valve, and
another GTA welding device which is configured to control the other solenoid valve.

10. A gas supply method comprising:
a decompression step in which the pressure of the shield gas is reduced by using the single-stage decompressor so that the pressure of the shielding gas led out from the gas supply source filled with the shielding gas at high pressure becomes a predetermined pressure; and
a back pressure applying step in which when the solenoid valve is opened and closed, which is provided in the gas supply line 23 of which one end is connected to the single-stage decompressor and the other end is connected to a use destination of the shielding gas, a back pressure is applied in the gas supply line positioned on the upstream side of the flow regulating valve by the flow regulating valve disposed at the latter stage of the solenoid valve.

11. The gas supply method according to claim 10, wherein the use destination of the shield gas is a welding torch and the shield gas is used.

12. The gas supply method according to claim 10, wherein a pilot gas is supplied instead of the shield gas.
